(19) United States
(12) Patent Application Publication
(10) Pub. No.: US 2023/0268523 A1
(43) Pub. Date: Aug. 24, 2023

(54) METHOD FOR JOINING AT LEAST TWO COMPONENTS OF A FUEL CELL AND DEVICE FOR CARRYING OUT THE METHOD

(71) Applicant: AUDI AG, Ingolstadt (DE)

(72) Inventors: Daniel BÖHM, Neuenstadt (DE); Jan-Philipp WEBERPALS, Abstatt (DE); Markus GRETZER, Eichstätt (DE); Eva HEUBERGER, Ingolstadt (DE)

(21) Appl. No.: 18/043,564

(22) PCT Filed: Sep. 7, 2021
(86) PCT No.: PCT/EP2021/074606

§ 371 Date: Feb. 28, 2023

(30) Foreign Application Priority Data
Sep. 11, 2020 (DE) 10 2020 123 694.8

(51) Int. Cl. H01M 8/0297; B23K 26/244; B23K 26/082; B23K 26/08; B23K 26/06; B23K 26/0622

(52) U.S. Cl. CPC H01M 8/0297; B23K 26/244; B23K 26/0821; B23K 26/083; B23K 26/0643; B23K 26/0622; B23K 2101/36

(57) ABSTRACT

A method for joining at least two components of a fuel cell, especially for joining two single plates of a fuel cell to make a bipolar plate, comprises: providing a first component of the fuel cell and providing at least one second component of the fuel cell; and directing a pulsed laser beam of a laser apparatus onto a rotating mirrored polygon wheel, by which the laser beam forms a joint line consisting of a plurality of overlapping pointlike and/or line-shaped joining locations on the components. A device for carrying out the method is also provided.

### BACKGROUND

### Technical Field

Embodiments of the invention relate to a method for joining at least two components of a fuel cell, especially for joining two single plates of a fuel cell to make a bipolar plate.

### Description of the Related Art

Bipolar plates are used in fuel cells and especially in fuel cell stacks. With the help of the bipolar plates, the fuel is taken and distributed on the one hand to an adjacent anode of a first fuel cell and the cathode gas to a cathode of a second adjacent fuel cell, while the bipolar plate furthermore provides conduits to supply a cooling medium. A bipolar plate is usually made of two single plates formed as half-shells, which are glued together in the case of bipolar plates formed from graphite. Metallic bipolar plates typically comprise two single plates welded together at least for a portion. A device for continuous production of bipolar plates making use of a laser welding apparatus is shown in DE 10 2018 219 056 A1. In WO 2018/237 049 A1, the additive fabrication of bipolar plates making use of a laser sintering process is described. A device and a welding method for welding together two single plates to form a bipolar plate are described by US 2020/0 206 843 A1.

It has been discovered that there is a risk of pore formation in the laser welding of components of a fuel cell, especially in the laser welding of bipolar plates, due to an excessively strong local input of heat in the single plates. Due to this overly intense heating, leaks may occur at weld seams, becoming especially pronounced when the bipolar plates are formed with a very long weld seam. Because of the intensified heat input in the joined material, an unwanted warpage of the component may occur, having negative effects on the subsequent process chain for the production of the fuel cell, especially during its assembly.

### BRIEF SUMMARY

Some embodiments include a method for joining of at least two components of a fuel cell as well as a device to carry out the method, where there is less heat input in the material so that the shortcomings known in the prior art are reduced.

In some embodiments, a method may include:
providing a first component of the fuel cell and providing at least one second component of the fuel cell,
directing a pulsed laser beam of a laser apparatus onto a rotating mirrored polygon wheel, by which the laser beam forms a joint line consisting of a plurality of overlapping pointlike and/or line-shaped joining locations on the components.

With this method, it is not only possible to connect, for example, two (metallic) single plates to form a bipolar plate, but also other components of a fuel cell can be joined together in a permanent material connection. Thus, it is possible with the method for example to join the membrane electrode assembly to a bipolar plate or a single plate at the same time, while the laser beam melts sealing material for example so much that it develops adhesive properties and binds the individual components intimately together upon cooling down. By joining may be meant a welding together of the two components. In some embodiments, a unit cell can also be bound in an assemblage in permanent intimate manner.

The joining process may occur with the use of a new laser technology, employing the polygon wheel. The polygon wheel can serve as a high-speed scanner (such as a high-speed galvanoscanner), which rotates with a rotation of 1000 to 12,000 revolutions per minute. If one registers—in slow motion—individual snapshots of the laser irradiation of the polygon wheel, one will discover that many individual sites on the surface of the components have been irradiated with the laser, due to the use of a pulsed laser source and due to the deflection of the beam by the envelope surface of the polygon wheel, varying in time, at which sites the pointlike and/or line-shaped joining locations are produced and result in the joining of the components. This method is especially suitable for line-oriented flat applications, because in this way the process time can be enormously reduced. Furthermore, thanks to the use of the rotating polygon wheel, an overall smaller heat input in the raw material can be achieved. In other words, a quasistationary processing of the components with reduced heat input can also be achieved in this way.

It is not absolutely necessary to produce rotationally symmetrical or entirely circular shaped points when creating the joining locations, so that it is also possible to create nonround elliptical joining locations or those which consist of short lines. In order to provide other laser spot geometries, such as rectangular or square spot geometries for the pointlike and/or line-shaped joining locations, at least one beam shaping element can be positioned in the beam path.

The mirrored polygon wheel may have a base surface formed as a regular polygon, a top surface corresponding to the base surface, and an envelope surface joining the base surface to the top surface and formed from mirrored rectangles. The polygon wheel is mounted so that it can turn about an axis of rotation, and an electrical drive unit may be present and designed to drive the polygon wheel in rotation about the axis of rotation, which is oriented perpendicular to the direction of incidence of the laser beams. When the laser beam impinges on the mirrored rectangles of the envelope surface of the polygon wheel it is reflected, and because of the rotation of the polygon wheel there is a variable deflection in time, so that a succession of overlapping individual points and/or lines impinge on the components and become the joining locations.

Thanks to the deflection of the laser beam by the polygon wheel, it becomes possible to completely “scan” the two components in one dimension and thus completely join them in one dimension, especially by welding. Whether only a single polygon wheel is enough or whether a cascade of multiple polygon wheels with one or more laser apparatus is required will depend for example on the dimensions of the polygon wheel or its mirrored envelope surfaces, the size of the components being joined, and the distance of the polygon wheel from the components being joined. Whether points or lines are created in the joining process is dependent, for example, on the width of the mirrored rectangles of the envelope surface of the polygon wheel at which the laser beam is directed, and by which the laser beam is deflected.

The irradiation of at least one polygon wheel is done with the laser apparatus, which is designed in particular as a pulsed laser. For this, a laser which generates ultrashort light pulses with a pulse duration of at most 10⁻⁹ seconds can be used. It is also possible to use a picosecond laser with a pulse duration between 10⁻⁹ and 10⁻¹² seconds. The use of a femtosecond laser with a pulse duration between 10⁻¹² and 10⁻¹⁵ seconds is also possible. The heat input in the material can likewise be controlled by the length of the pulses, the heat input increasing with larger pulse duration. If the pulse duration is especially long, the laser apparatus approximates to a cw-laser, where cw stands for continuous wave and means a wave emitted constant over time. If the pulse is appropriately long, it is then possible for the components to be entirely “traversed” during this single pulse, while a multiple “traversing” or “scanning” within the very same pulse can occur on account of the high-speed rotation of the polygon wheel. Also, in this way, only very little heat is put into the material on account of the fast process. The use of multiple laser apparatus is possible. The laser source of the laser apparatus can be for example a gas laser, a semiconductor laser or a solid state laser.

It is usually necessary to connect the components to each other in a permanent intimate manner along a desired two-dimensional contour. In order to produce such a two-dimensional joint contour, it may be advantageous when the components and the laser beam are moved relative to each other, the relative movement forming a two-dimensional joint contour.

The relative movement between the two components and the laser beam impinging on the components is generated for example by the feed of a transport device for the transporting of the components. This ensures that a series of individual pointlike joining locations is produced so as to form the joint line. For example, multiple series of overlapping pointlike joining locations can also be created, which then result in an especially tight joint line.

The laser beam is directed at the components substantially perpendicular to the plane in which the components lie. Thus, in this way, weld seams are produced, and the seams can be continuous, which furthermore assures a reliable sealing function.

The use of an adjustable optical deflection device may be advantageous, since joint lines can then be produced which include a portion oriented perpendicular to the feed direction of the transport device. If it is necessary to produce a joint line oriented overall perpendicular to the feed direction of the transport device, then it may be advantageous for the optical deflection device to be moved or to be movable with a speed which compensates for the feed rate of the transport device. In this way, it is possible for straight joint lines to be produced even when the raw material or the components are transported by the transport device continuously along the feed direction.

By analogy with an ink jet printer, it is also possible for the relative movement to be produced by moving a laser head of the laser apparatus, especially one which is movable perpendicular to the feed direction, with entrainment of the polygon wheel. In this way it is also possible to “steer toward” the most diverse points of the components in order to irradiate them with the laser beam and produce a desired contour of a joint line consisting of a plurality of overlapping pointlike and/or line-shaped joining locations.

It is possible to fold and/or divide up the laser beam in single or multiple manner and thereby irradiate a multitude of polygon wheels with the laser light emitted by a single laser source, so that a diversity of pluralities of pointlike and/or line-shaped joining locations can be produced on the components at the same time.

In order to additionally ensure that the joining locations are present on the components only as points or with not too long lines, it may be advantageous for the joining locations to be created by a high-frequency clocked switching on and off of the laser apparatus, especially the corresponding laser source.

The benefits, configurations and effects explained in connection with the method described herein hold equally for the device described herein for carrying out the method.

This device comprises in particular a laser apparatus which is adapted to directing a pulsed laser beam. The laser beam of the laser apparatus is directed at a mirrored polygon wheel which is driven or can be driven in rotation, especially by an electric motor, and which is adapted in turn to deflect the laser beam and thereby form a joint line consisting of a plurality of overlapping pointlike and/or line-shaped joining locations on the components.

In this way, it is possible with the device described herein to join together two components of a fuel cell without putting too much heat into the material.

A transport device may be present and adapted to move the components relative to the laser beam impinging on the components in order to form a two-dimensional joint contour.

In order also to form joint lines having one portion perpendicular to the feed direction of the transport device, it may be advantageous for a movable optical deflection device to be placed downstream from the polygon wheel in the path of the laser beam, which is adapted to deflect the laser beam in dependence on the feed rate of the transport device. Thus, in this way, the movement of the components produced by the feed can be compensated by means of the deflection device, so that rectilinear joint lines can be created during simultaneous transport of the components by the transport device. This drastically shortens the production time and shortens the clock times.

In order to form the pointlike or not too long line-shaped joining locations, it may be advantageous for the laser controls to be adapted to switch the laser apparatus on and off with a high-frequency clock rate.

In order to provide a diversity of possible contours for the joint line, it may be advantageous for a movable laser head of the laser apparatus to be present, which can move in particular perpendicular to the feed direction, and which is movably mounted with entrainment of the polygon wheel.

Some embodiments are not confined to the joining of components having prefabricated dimensions, but can also be used for production facilities in a continuous process, i.e., for strip-shaped raw material. In this case, the device can be associated with a cutting mechanism, which is adapted to singulate the joined strip-shaped raw material into individual components or trim them to final dimension. A “roll to roll” machining is also possible.

The features and combinations of features mentioned above in the description as well as the features and combinations of features mentioned below in the description of the figures and/or shown solely in the figures can be used not only in the particular indicated combination, but also in other combinations or standing alone. Thus, embodiments not shown or explained explicitly in the figures, yet deriving and producible from the explained embodiments by separated combinations of features shall also be deemed to be encompassed and disclosed herein.

### BRIEF DESCRIPTION OF THE SEVERAL VIEWS OF THE DRAWINGS

Further benefits, features and details will emerge from the claims, the following description of embodiments, and the drawings.

FIG. 1 shows a cross sectional detail view of one portion of a fuel cell stack with a bipolar plate formed from two single plates.

FIG. 2 shows a schematic side view of a device for joining of at least two components of a fuel cell, especially for joining of single plates to form a bipolar plate.

FIG. 3 shows a schematic detail view of the surface of an already partly joined bipolar plate.

FIG. 4 shows a schematic view of the device of FIG. 3, in which the making of the line is illustrated, showing for sake of clarity the bipolar plate in a top view and the device in a side view.

### DETAILED DESCRIPTION

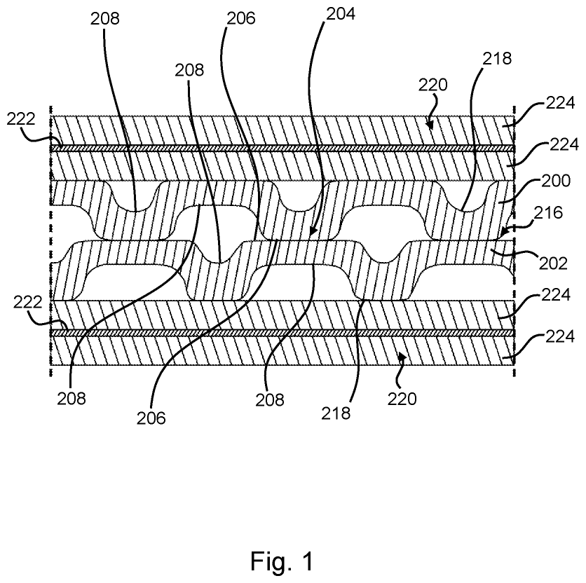

FIG. 1 shows a cutout view of a fuel cell stack, formed from multiple fuel cells 220. Each fuel cell 220 is formed with a membrane electrode assembly 222, which comprises a proton-conducting membrane associated with an electrode on either side. The membrane electrode assembly 222 is designed to carry out the electrochemical reaction of the fuel cell. In this process, a fuel (such as hydrogen) is taken to the electrode forming the anode, where it is oxidized catalytically to protons, giving off electrons. These protons are transported through the proton-conducting membrane (or ion exchange membrane) to the cathode. The electrons taken away from the fuel cell flow across an electrical consumer, such as across an electric motor for driving a vehicle, or to a battery. The electrons are then taken to the cathode or electrons are provided at it. At the cathode, the oxidation medium (such as oxygen or air containing oxygen) is reduced to anions by uptake of electrons, which react immediately with the protons to form water.

With the aid of bipolar plates 216, the fuel or the cathode gas is taken to gas diffusion layers 224, which distribute the respective gases diffusely and take them to the electrodes of the membrane electrode assembly 222. The fuel, the oxidation medium and optionally a cooling medium are taken through ducts 208 of the bipolar plate 216, which are bounded on both sides by webs 206 of the bipolar plate 216 having web backs. As can be seen from FIG. 1, a set of the web backs lie against a gas diffusion layer 224, so that a reactant flowing in the ducts 208 can be dispensed to the gas diffusion layer 224 and thus to the electrode of the membrane electrode assembly 222.

The bipolar plate 216 in the present instance comprises two single plates 200, 202 placed on one another and joined together selectively at their facing webs 206, especially at their respective web backs, in particular by welding. The facing webs 206 of the single plates 200, 202 typically form conduits for a cooling medium with the ducts 208 lying between the webs 206.

It is furthermore evident from FIG. 1 that the webs 206 or their web backs of the single plates 200, 202 need not have the same width, so that different widths and or depths may be present for the ducts 208. However, for a permanent connection of two single plates 200, 202, it should be assured that at least two of the oppositely positioned webs 206 which lie against each other can be permanently connected to each other, namely joined, and especially welded together.

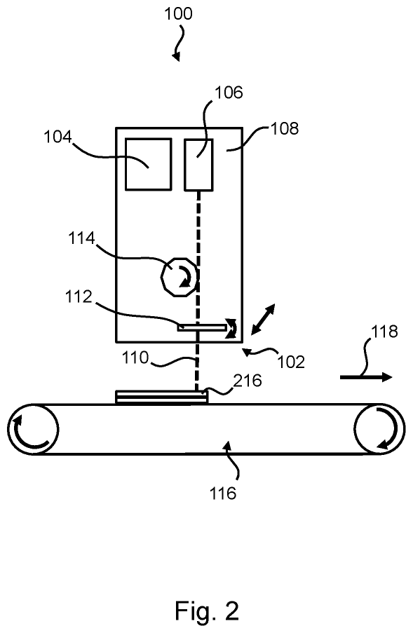

FIG. 2 presents a device 100 for joining at least two components of a fuel cell 218, being designed in the present instance especially for joining two single plates 200, 202 to make a bipolar plate 216. This device 100 comprises a laser apparatus 108, having a laser source 106 for the emission of a pulsed laser beam 110. The laser source 108 can be a gas laser, a semiconductor laser or a solid state laser, while in particular a CO₂ laser or a Nd:YAG laser or a semiconductor laser/diode laser or a Yb:YAG laser can be used. The individual components of the laser apparatus 108 are activated by laser controls 104.

The laser source 106 directs the laser beam 110 onto a mirrored polygon wheel 114, driven in rotation by an electric motor. This mirrored polygon wheel 114 is adapted to deflect the laser beam 110 very rapidly and in dependence on the angular position of the polygon wheel 114 among a plurality of angles. The laser controls 104 can be adapted to switch the laser apparatus 108, especially the laser source 106, on and off with a high-frequency clock rate, in order to further guarantee that no excessively long line-shaped laser beams 110 are formed, resulting in a large heat input in the raw material and therefore in the single plates 200, 202 of the bipolar plate 216.

Moreover, the laser apparatus 108 comprises an adjustable optical deflection device 112 situated downstream from the polygon wheel 114 in the path of the laser beam 110, being adapted to deflect the laser beam 110 in dependence on a feed rate of a transport device 116. The transport device 116 transports the single plates 200, 202 in a feed direction 118. Thanks to the feeding of the transport device 116, two-dimensional joint contours can be realized. In order to provide any other desired two-dimensional joint contours for the joining process, the laser apparatus 108 can furthermore be outfitted with a laser head 102, which can be moved or “travel” by electric motor perpendicular to the feed direction 118 of the transport device 116, as indicated by the diagonally positioned double arrow shown next to the laser apparatus 108.

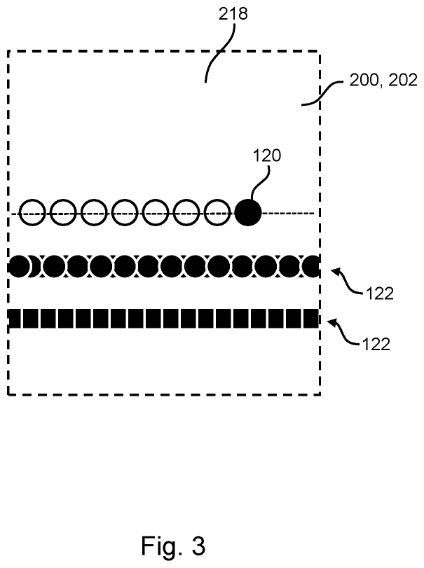

The functioning of the device 100 is illustrated with the aid of FIG. 3, which shows a top view of a surface 218 of the single plates 200, 202. Once the transport device 116 has arranged or positioned the components of the fuel cell 218 opposite the laser apparatus 108, the laser beam 110 is directed onto the rotating, mirrored polygon wheel 114. In this way, the laser beam 110 is deflected at a number of angles due to the rotation of the wheel and forms on the single plates 200, 202 a joint line 122 consisting of a plurality of overlapping pointlike and/or line-shaped joining locations 120, by which the two plates are joined together in permanent intimate manner. The laser beam 110 can or should impinge on the components in focused manner in order to effectively bring about a specific melting of the material and a joining of the components. In order to produce any given joint contours, the plates are moved relative to the laser beam 110, either by the feeding of the transport device 116 and/or by the movable laser head 102.

Thanks to this successive pointlike or dashlike arrangement, not a slight amount of heat is put into the material when producing a continuous joint line 122, so that there is less heat-induced warpage of the component. Optionally, a given line can also be traveled repeatedly with the pointlike joining locations 120, in order to form a closed or thicker joint line 122 from the overlapping joining locations 120.

Moreover, it can be seen from FIG. 3 that the pointlike and/or line-shaped joining locations 120 need not necessarily be circular round in shape. Therefore, the use of other melting spot geometries may also be considered, which can be created for example by means of suitable beam-shaping elements. Thus, the joint line 122 shown at the bottom of FIG. 3 is an overlapping series of rectangular, especially square, pointlike joining locations 120, requiring less overlap than round circular joining locations 120 in order to result in a desired tightness of the assemblage.

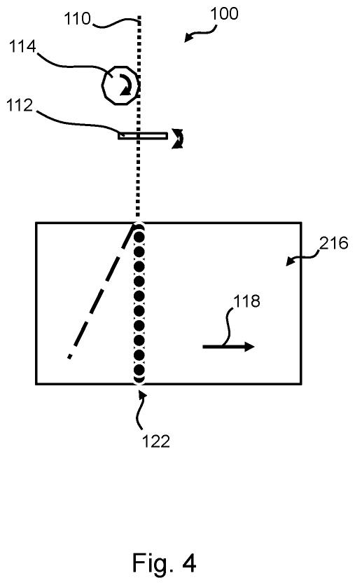

In order to further speed up the process of making the joined assemblage, the optical deflection device 112 is used, which shall be discussed below with reference to FIG. 4. For sake of clarity, FIG. 4 combines the side view of the device 100, shown only simplified, and the top view of the surface 218 of the single plates 200, 202 which are to be welded to make a bipolar plate 216.

The bipolar plate 216 is transported by the transport device 116 along the feed direction 118. If the optical deflection device 112 were not used, this would result in the dashed representation of the joint line 122 formed from multiple pointlike and/or line-shaped joining locations 120. The optical deflection device 112, which is formed in particular as a mirror or a prism, can be moved or swiveled in the manner of a scanner. The optical deflection device 112 can be moved in this process in dependence on the feed rate of the transport device 116. In this way, thanks to the use of the optical deflection device 112, it is possible to create a joint line 122 oriented perpendicular to the feed direction 118, as can be seen in the figure. The movement or deflection of the laser beam 110 may occur at a speed which just compensates for the feed rate of the transport device 116. In this way, a joint line 122 can also be created when the bipolar plate 216 is being transported by the transport device 116 in the feed direction 118.

Hence, a device 100 and a method are indicated for the joining of at least two components of a fuel cell 218, being distinguished from the prior art of known methods by a shortened clock cycle. The device 100 and the method described herein are therefore suited to a mass production and they reduce the reject rate of the production as compared to known methods and devices, especially in the production of bipolar plates 216, on account of less heat input in the (raw) material of the components. The joint lines 122 formed as described herein assure the necessary tightness and the required electrical contacting, and because of less heat input in the raw materials there is little or no heat-induced warpage, which might be detrimental in the following production stages.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for joining at least two components of a fuel cell, comprising:
providing a first component of the fuel cell and providing at least one second component of the fuel cell; and
directing a pulsed laser beam of a laser apparatus onto a rotating mirrored polygon wheel, by which the laser beam forms a joint line consisting of a plurality of overlapping pointlike and/or line-shaped joining locations on the components.

2. The method according to claim 1, wherein the components and the laser beam are moved relative to each other, and a two-dimensional joint contour is formed by the relative movement.

3. The method according to claim 2, wherein the relative movement is created by a feed of a transport device for transporting the components.

4. The method according to claim 3, wherein in order to form the joint line, which includes a portion oriented perpendicular to the feed direction of the transport device, the laser beam partially broadened by the polygon wheel is deflected by an adjustable optical deflection device in dependence on the feed.

5. The method according to claim 4, wherein the optical deflection device is moved with a speed compensating for the feed rate in order to form a joint line on the components oriented perpendicular to the feed direction.

6. The method according to claim 1, wherein the relative movement is generated by moving a movable laser head of the laser apparatus with entrainment of the polygon wheel.

7. A device for carrying out a method for joining at least two components of a fuel cell, including providing a first component of the fuel cell and providing at least one second component of the fuel cell, and directing a pulsed laser beam of a laser apparatus onto a rotating mirrored polygon wheel, by which the laser beam forms a joint line consisting of a plurality of overlapping pointlike and/or line-shaped joining locations on the components, the device comprising:
a laser apparatus; and
a rotatably driven mirrored polygon wheel,
wherein the laser apparatus is adapted to direct a pulsed laser beam onto the rotatably driven mirrored polygon wheel, and
which is wherein the rotatably driven mirrored polygon wheel is adapted to deflect the laser beam and thus form a joint line of a plurality of overlapping pointlike and/or line-shaped joining locations on the components.

8. The device according to claim 7, wherein a transport device is present and adapted to move the components relative to the laser beam impinging on the components in order to form a two-dimensional joint contour.

9. The device according to claim 8, wherein a movable optical deflection device is placed downstream from the polygon wheel in the path of the laser beam, which is adapted to deflect the laser beam in dependence on a feed rate of the transport device.

10. The device according to claim 7, wherein a movable laser head of the laser apparatus is present, which is movably mounted with entrainment of the polygon wheel.

11. The method according to claim 1, wherein the method for joining at least two components of a fuel cell is a method for joining two single plates of a fuel cell to make a bipolar plate.
